(19) United States
(12) Patent Application Publication
(10) Pub. No.: US 2021/0144241 A1
(43) Pub. Date: May 13, 2021

(54) MOBILE TERMINAL

(71) Applicant: LG ELECTRONICS INC., Seoul (KR)

(72) Inventors: Gihwan KIM, Seoul (KR); Myungsu CHOI, Seoul (KR); Jeonghwan HWANG, Seoul (KR)

(73) Assignee: LG ELECTRONICS INC., Seoul (KR)

(21) Appl. No.: 16/623,626

(22) PCT Filed: May 30, 2018
(86) PCT No.: PCT/KR2018/006151

§ 371 Date: Dec. 17, 2019

(51) Int. Cl. H04M 1/02; H04M 1/22

(52) U.S. Cl. CPC H04M 1/0283; H04M 1/0277; H04M 1/0266; H04M 1/22

(57) ABSTRACT

In order to transmit information such as notification and the like in a region other than a display unit and generate visual effects, there is provided a mobile terminal including a display unit including a window and a display panel, a support frame positioned at a rear of the display unit, a wire receiving groove defined along an edge of the support frame, a light emitting unit received in the wire receiving groove, a decoration frame made of a light transmitting material, wherein the decoration frame covers an exposed region of the received light emitting unit, and an opaque shielding frame disposed between the light emitting unit and the display panel.

### TECHNICAL FIELD

The present disclosure relates to a light emitting structure of a mobile terminal having a light emitting function.

### BACKGROUND ART

In a conventional mobile terminal, information provision, notification, or output of design effects is mainly implemented using a display unit.

Although there is an advantage in that output data may be changed as desired, but the above-mentioned function may only be performed when the display unit is activated. Further, there are disadvantages in that power consumption is large, and a region of the mobile terminal in which the display unit is disposed is limited.

Therefore, the notification and design purpose may be achieved in a region other than the region in which the display unit is disposed. In one form, the mobile terminal may define a light-emitting region in one region other than the region in which the display unit is disposed.

The present disclosure will be describe a specific method for defining such a light emitting region.

Furthermore, the present disclosure will also examine a specific method for solving a light leakage phenomenon that may occur in the display unit caused by the light emission, an adverse effect that may affect radiation of an antenna, and the like.

### DISCLOSURE

### Technical Problem

A purpose of the present disclosure is to solve problems caused by an only configuration of a display unit in a mobile terminal, which is the above-described problem.

### Technical Solutions

One aspect of the present disclosure proposes a mobile terminal including a display unit including a window and a display panel, a support frame positioned at a rear of the display unit, a wire receiving groove defined along an edge of the support frame, a light emitting unit received in the wire receiving groove, a decoration frame made of a light transmitting material, wherein the decoration frame covers an exposed region of the received light emitting unit, and an opaque shielding frame disposed between the light emitting unit and the display panel.

In one implementation, the decoration frame and the shielding frame may be formed integral with each other and made of a light transmitting material, and opaque paint may be printed on the shielding frame.

In one implementation, the shielding frame may form a closed loop along a perimeter of the display panel, and the shielding frame may further include a reinforcing plate for blocking at least one region of an opening defined by the closed loop.

In one implementation, the reinforcing plate may contain a metal material, and the shielding frame may be double-injected with the reinforcing plate.

In one implementation, the mobile terminal may further include a hook formed on the decoration frame, wherein the hook may protrude horizontally outward, and a projection formed on the support frame, wherein the projection may protrude horizontally inward to be fastened with the hook.

In one implementation, the light emitting unit may include an optical fiber made of a non-conductive material, and a light source disposed at one end of the optical fiber, wherein light emitted from the light source may propagate into the optical fiber.

In one implementation, the light source may be disposed at a position corresponding to a receiver or an input/output terminal in a main printed circuit board region.

In one implementation, the support frame may contain a metal material, wherein the support frame may further include an antenna slit defined in the support frame, and a mold portion filling the antenna slit, and wherein the optical fiber may pass through a region corresponding to the antenna slit.

In one implementation, the light emitting unit may include an electroluminescent wire.

In one implementation, the support frame may contain a metal material, wherein the support frame may further include an antenna slit defined in the support frame, and a mold portion filling the antenna slit, and wherein the electroluminescent wire may be spaced apart from a region corresponding to the antenna slit by a predetermined distance or greater.

Another aspect of the present disclosure proposes a mobile terminal including a display unit, a metal support frame positioned at a rear of the display unit, wherein the support frame forms a side outer shape of the mobile terminal, at least one antenna slit defined in a side surface of the support frame, a light transmissive light emitting diffuser, a light transmissive diffuser disposed in the antenna slit, and a light source disposed inside the light emitting diffuser.

In one implementation, the light emitting diffuser may define a hollow portion such that an inner surface of the light emitting diffuser may be spaced apart from the light source.

In one implementation, the light emitting diffuser may be disposed such that an inner surface of the light emitting diffuser is adjacent to the light source, and wherein the light emitting diffuser may further include a transmitting portion having a cross-sectional area increasing outwardly.

In one implementation, the mobile terminal may further include a main printed circuit board disposed on one surface of the support frame, and wherein the light source may be disposed on one surface of the main printed circuit board.

In one implementation, the mobile terminal may further include a main printed circuit board disposed on one surface of the support frame, and a flexible printed circuit board mounting the light source thereon, wherein the flexible printed circuit board may be connected to the main printed circuit board, and wherein a region of the flexible printed circuit board mounting the light source therein may face a side of the mobile terminal.

In one implementation, the mobile terminal may further include a reinforcing resin portion disposed between the slit and the light emitting diffuser.

### Advantageous Effects

Effects of the mobile terminal according to the present disclosure are as follows.

According to at least one of embodiments of the present disclosure, information such as a notification and the like may be provided in a region other than the display unit.

Further, according to at least one of embodiments of the present disclosure, a design effect of the mobile terminal may be improved.

Further, according to at least one of embodiments of the present disclosure, an antenna performance may not be affected.

Further, according to at least one of embodiments of the present disclosure, a notification structure may be implemented using the slit for implementing the antenna performance.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### DESCRIPTION OF DRAWINGS

FIG. 1A is a block diagram of a mobile terminal in accordance with the present disclosure.

FIGS. 1B and 1C are conceptual views of one example of the mobile terminal, viewed from different directions;

FIG. 2 is a partial exploded front view of a mobile terminal associated with the present disclosure.

FIG. 3 is a cross-sectional view taken along a line A-A′ of a mobile terminal of FIG. 2 in a coupled state.

FIG. 4 is a partial cross-sectional view of another mobile terminal associated with the present disclosure.

FIG. 5 shows a coupled body of a shielding frame and a reinforcing plate.

FIGS. 6 to 8 are conceptual views of three embodiments of a loop light emission scheme associated with a first embodiment.

FIGS. 9 and 10 are conceptual views illustrating two embodiments of a side light emission scheme.

FIG. 11A is a partial cross-sectional view of a mobile terminal associated with a second embodiment. FIG. 11B is a structural diagram of an electroluminescent wire. Further, FIG. 12 is a partially exploded front view of a mobile terminal associated with a second embodiment.

FIG. 13 is a partial enlarged view of a mobile terminal associated with the present disclosure.

FIG. 14 is a front view of a portion of a mobile terminal associated with the present disclosure, and FIG. 15 is a conceptual view of a cross-section taken along a line B-B′ of FIG. 14.

FIG. 16 is a partial front view of a mobile terminal associated with the present disclosure.

FIG. 17 is a cross-sectional view taken along a line C-C′ of FIG. 16.

FIG. 18 is an embodiment associated with embodiments of FIGS. 14 and 16.

FIG. 19 is an external perspective view of a mobile terminal, which is associated with an embodiment of a mobile terminal associated with the present disclosure.

FIG. 20 shows a rear view of a corresponding region of FIG. 19.

FIG. 21 illustrates a rear view of an embodiment of a region of a support frame associated with the present disclosure.

FIG. 22 is a partial front view of a mobile terminal associated with the present disclosure, and FIG. 23 is a cross-sectional view taken along a line D-D′ of FIG. 22.

### BEST MODEL

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. Referring now to FIG. 1A, the mobile terminal 100 is shown having wireless communication unit 110 configured with several commonly implemented components. It is understood that implementing all of the illustrated components is not a requirement, and that greater or fewer components may alternatively be implemented.

More specifically, the wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks.

To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, the sensing unit 140 may alternatively or additionally include other types of sensors or devices, such as a proximity sensor 141 and an illumination sensor 142, a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

1571 The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output, or activating application programs stored in the memory 170.

To drive the application programs stored in the memory 170, the controller 180 may be implemented to control a predetermined number of the components mentioned above in reference with FIG. 1A. Moreover, the controller 180 may be implemented to combinedly operate two or more of the components provided in the mobile terminal 100 to drive the application programs.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Some or more of the components may be operated cooperatively to embody an operation, control or a control method of the mobile terminal in accordance with embodiments of the present disclosure. Also, the operation, control or control method of the mobile terminal may be realized on the mobile terminal by driving of one or more application problems stored in the memory 170.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

Here, the terminal body may be understood to refer to the concept of this bore a mobile terminal 100 to at least one of the aggregate.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may include the display unit 151, the first and second audio output modules 152a and 152b, the proximity sensor 141, the illuminance sensor 142, the optical output module 154, the first and second cameras 121a and 121b, the first and second manipulation units 123a and 123b, the microphone 122 and the interface unit 160.

It will be described for the mobile terminal as shown in FIGS. 1B and 1C. The display unit 151, the first audio output module 152a, the proximity sensor 141, an illumination sensor 142, the optical output module 154, the first camera 121a and the first manipulation unit 123a are arranged in front surface of the terminal body, the second manipulation unit 123b, the microphone 122 and interface unit 160 are arranged in side surface of the terminal body, and the second audio output modules 152b and the second camera 121b are arranged in rear surface of the terminal body.

It is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

A flash 124 is shown located adjacent to the second camera 121b. When an image of a subject is captured with the camera 121b, the flash 124 may illuminate the subject.

The second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 (see FIG. 1A). may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body.

The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

FIG. 2 is a partial exploded front view of the mobile terminal 100 associated with the present disclosure, and FIG. 3 is a cross-sectional view taken along a line A-A′ of the mobile terminal 100 of FIG. 2 in a coupled state.

The display unit 151 includes a display panel 151b and the window 151a exposed on a front surface of the mobile terminal 100 to cover the display panel 151b.

A support frame 220 is disposed on a rear surface of the display unit 151. The support frame 220 supports or fixes the display unit 151 directly or indirectly.

The support frame 220 may simultaneously form an electronic component mounting portion on which the electronic components of the mobile terminal 100 are mounted. In particular, a main printed circuit board (PCB) 241 may be seated and fixed on the support frame 220.

In order for a light emitting region to be defined outward of the display unit 151, the support frame 220 of the present embodiment may surround an outer edge of the display unit 151 when viewed from the front of the mobile terminal 100.

That is, the support frame 220 may define a portion in an outer region of a front surface of the mobile terminal 100.

Alternatively, the support frame 220 may define a portion in an outer region of a side surface of the mobile terminal 100.

The support frame 220 may be the front case or the middle case described with reference to FIG. 1.

The mobile terminal 100 may have a light emitting unit 230 that may selectively emit light. The light emitting unit 230 may be provided on an outer edge of the support frame 220.

The support frame 220 may define a wire receiving groove 221 for receiving the light emitting unit 230 therein. The wire receiving groove 221 may be defined in the support frame 220, but may be defined separately from the support frame 220 in some cases. However, when the wire receiving groove 221 is defined integrally with the support frame 220, production is relatively easy, production cost is able to be reduced, and volume increase is able to be minimized.

The wire receiving groove 221 may be defined along the edge of the support frame 220.

A shape of a cross-section of the wire receiving groove 221 may correspond to a shape of a cross-section of the light emitting unit 230. In particular, outer sides of rear and side surfaces of the light emitting unit 230 may correspond to the support frame 220.

A decoration frame 211 covers a region of the light emitting unit 230 to cover a front exposed region of the light emitting unit 230. Further, the decoration frame 211 is optically transparent, so that the light emitting unit 230 may be seen from the outside when the light emitting unit 230 emits the light.

The decoration frame 211 may not only simply serve to allow the light emitting unit 230 to be seen from the outside, but also serve as a diffuser to allow the light from the light emitting unit 230 to be diffused and uniformly seen.

The decoration frame 211 may form an outer boundary of the window 151a of the display unit 151, so that a front edge of the mobile terminal 100 may emit light.

A shielding frame 251 prevents light leakage, which is a phenomenon in which the light emitted from the light emitting unit 230 is introduced into the display unit 151, and then is seen from the display unit 151. For example, the shielding frame 251 may be provided in a form of a sidewall standing upright at a portion between the light emitting unit 230 and the display unit 151.

One end of the shielding frame 251 in the sidewall form may be fixed to the support frame 220 and the other end thereof may support and be fixed to the rear surface of the window 151a of the display unit 151.

The shielding frame 251 may be fixed to the decoration frame 211. Since it is required that the decoration frame 211 is optically transparent and the shielding frame 251 is optically opaque, the decoration frame 211 and the shielding frame 251 may be respectively made of materials different from each other. Therefore, the shielding frame 251 and the decoration frame 211 may be formed in a double-injection manner and coupled with each other.

Alternatively, both the decoration frame 211 and the shielding frame 251 may be made of a light transmitting material in the same manner, and a region of the decoration frame 211 corresponding to the shielding frame 251 may be coated with the optically opaque material. When the decoration frame 211 and the shielding frame 251 are made of the same material, the decoration frame 211 and the shielding frame 251 may be integrally formed.

The decoration frame 211 may have a hook 2111. The hook 2111 protrudes horizontally outward of the mobile terminal 100 and is fastened to the support frame 220 to prevent the decoration frame 2111 from being separated from the support frame 220. The support frame 220 may have a projection 222 protruding horizontally into the mobile terminal 100 and having a corresponding shape for fastening the hook 2111.

The shielding frame 251 may also be bonded to the support frame 220.

The shielding frame 251 forms a closed loop around the display panel 151b. Therefore, the shielding frame 251 has an unstable shape, so that there is a high risk of deformation or breakage during formation or coupling.

FIG. 4 is a partial cross-sectional view of another mobile terminal 100 associated with the present disclosure, and FIG. 5 shows a coupled body of the shielding frame 251 and the reinforcing plate 252.

In order to compensate for such problem, the reinforcing plate 252 may block at least one region of an opening of the shielding frame 251 to compensate for a rigidity of the shielding frame 251.

The reinforcing plate 252 may be disposed between the display unit 151 and the support frame 220. The reinforcing plate 252 may contain a metal material. For example, the reinforcing plate 252 may be made of a material such as STS, Al, or the like. In this case, the shielding frame 251 may be formed by double-injected with the reinforcing plate 252 of the metal material.

Hereinafter, two types of implementation schemes of the light emitting unit 230 will be described.

The light emitting unit 230 may be divided into a first embodiment, which is an optical fiber type light emitting unit 230a implemented by a light source 231 and an optical fiber 232 through which light from the light source 231 travels, and a second embodiment, which is an electroluminescent wire that emits light by itself.

### First Embodiment

As shown in FIG. 2, the light emitting unit 230 may be implemented in a form of a combination of the light source 231 that emits the light based on an electrical signal and the optical fiber 232 that receives the light emitted from the light source 231 and emits the light.

When the light emitting unit 230 is implemented by the combination of the light source 231 and the optical fiber 232, a material of the optical fiber 232 may be a non-conductor. The non-conducting optical fiber 232 does not affect a performance of an antenna of the mobile terminal 100, so that a freedom of design is increased.

That is, when the optical fiber type light emitting unit 230a is implemented, the optical fiber type light emitting unit 230a may be provided along an entire perimeter of the mobile terminal 100.

FIGS. 6 to 8 are conceptual views of three embodiments of a loop light emission scheme associated with the first embodiment.

The loop light emission scheme in which the optical fiber type light emitting unit 230a is provided along the entire perimeter of the mobile terminal 100 may be implemented in forms as shown in FIGS. 6 to 8.

In FIG. 6, the optical fiber type light emitting unit 230a may be implemented with a single light source 231 and an optical fiber 232, which is started from one side of the single light source 231 and led to the other side of the single light source 231. Light emitted from the light source 231 disposed at one end of the optical fiber 232 may be led to the other side of the optical fiber 232 from one side of the optical fiber 232. A position of the light source 231 may be defined in consideration of a shape of the printed circuit board and positions of other components. The light source 231 may be disposed at an upper corner of the mobile terminal 100 (see FIG. 6), or may be disposed at a lower, left, or right corner in some cases.

In particular, when the light source 231 is disposed near a receiver of the mobile terminal 100, or near an input/output terminal, impacts of the light source 231 on other electronic components may be minimized.

When the light emission is implemented for the entire perimeter of the mobile terminal 100 with the single light source 231 as shown in FIG. 6, since an amount of the light is not sufficient, the light emitting unit 230 with uniform brightness may not be implemented.

FIG. 7 shows that a plurality of light sources 231 are arranged to solve such problem. One light source 231 may emit light toward one side of the optical fiber 232, and the other light source 231 may emit light toward the other side of the optical fiber 232 to implement uniform brightness.

For an efficient mounting structure, the plurality of light sources 231 may be arranged adjacent to each other.

Alternatively, as shown in FIG. 8, four light sources 231 may be used to achieve uniform and bright light emission. Two light sources 231 and other two light sources 231 may be respectively arranged at sides opposite to each other to obtain a uniform amount of light.

FIGS. 9 and 10 are conceptual views illustrating two embodiments of a side light emission scheme.

The optical fiber 232 may be implemented in a side light emission scheme in which light is emitted toward two corner regions opposite to each other as shown in FIGS. 9 and 10, unlike the loop light emission scheme of FIGS. 6 to 8. FIGS. 9 and 10 assume that at least one light source and an optical fiber of the light emitting unit 230 are arranged at each of left and right corners. However, the at least one light source and the optical fiber of the light emitting unit 230 may be arranged at each of upper and lower corners as necessary.

In the case of side light emission scheme, since a length of the optical fiber 232 is smaller than that of the optical fiber in the entire loop emission scheme, it is relatively easy to implement the uniform light emission. However, at least two light sources 231 are required since disconnected regions are inevitably generated.

As shown in FIG. 9, two light sources 231 may be arranged at one side of a left optical fiber 232 and one side of a right optical fiber 232, respectively. Alternatively, as shown in FIG. 10, two of four light sources 231 may be respectively disposed at both sides of the left optical fiber 232 while remaining two thereof may be respectively disposed at both sides of the right optical fiber 232.

### Second Embodiment

The light emitting unit 230 may be embodied as an electroluminescent (EL) wire. Unlike the first embodiment, in the light emitting unit 230 implemented as an electroluminescent wire 233, the wire itself is conducted to emit light.

FIG. 11A is a partial cross-sectional view of the mobile terminal 100 associated with the second embodiment. FIG. 11B is a structural diagram of the electroluminescent wire 233. Further, FIG. 12 is a partially exploded front view of the mobile terminal 100 associated with the second embodiment.

The features of the first embodiment may be equally applied to features not to be described below within a range in which there is no contradiction.

Since the electroluminescent wire type light emitting unit 230b includes a conductor in a wire region, unlike the first embodiment, the electroluminescent wire type light emitting unit 230b generates noise in an antenna performance of the mobile terminal 100. Therefore, the conductor may be disposed only in a region where interference with the antenna does not occur.

For example, when a metal support frame 220 for antenna implementation includes an antenna slit 223 defined therein and a non-conductive mold portion 224 filling the antenna slit 223, and when each antenna slit 223 is defined in upper or lower sides of the support frame 220, each light emitting unit 230 may be disposed left or right sides of the mobile terminal 100.

In this connection, one end of the electroluminescent wire type light emitting unit 230b may be spaced apart from the antenna slit 223 of the support frame 220 by a predetermined distance or greater so as not to adversely affect the antenna performance.

The light emitting unit 230 may be implemented in a form of an electroluminescent sheet or a light emitting diode (LED) flexible printed circuit board (FPCB) in addition to the electroluminescent wire 233. Such components, like the electroluminescent wire, also include the conductor. Thus, each of such components is preferable to be disposed so as not to affect the antenna performance of the mobile terminal 100.

### Third Embodiment

FIG. 13 is a partial enlarged view of the mobile terminal 100 associated with the present disclosure.

As described above, when the support frame 220 is made of metal, the support frame 220 may simultaneously serve as an antenna. In order to implement an antenna performance of a specific frequency band, the support frame 220 has an antenna slit 223 which is a disconnected region.

Some embodiments below will describe a method for implementing the antenna slit 223 as the light emitting unit 230.

A slit light emitting unit 230c may be implemented by a light source 231 disposed inside the mobile terminal 100 and a light emitting diffuser 225 from which light emitted from the light source 231 is diffused and seen. The light emitting diffuser 225 is made of a light transmitting material, and is made of a non-conducting material to prevent antenna performance degradation. That is, the light emitting diffuser 225 may have the same physical properties as the decoration frame 211 described above.

Instead of inevitably defining the antenna slit 223 and filling the antenna slit 223 with the mold portion 224 in order to configure the antenna as in the prior art, the slit light emitting unit 230c is configured as the light emitting unit 230, thereby achieving a design synergistic effect and performing an additional function.

The slit light emitting unit 230c may be divided into a type in which the light source 231 is indirectly mounted on the main printed circuit board 241 via a flexible printed circuit board (FPCB) 242 and a type in which the light source 231 is directly mounted on the main printed circuit board 241.

Furthermore, a light emitting structure of the antenna slit 223 may be divided into a structure in which the light emitting diffuser 225 is separated from the light source 231 and a structure in which the light emitting diffuser 225 is connected with the light source 231 depending on a shape of the light emitting diffuser 225.

FIG. 14 is a front view of a portion of the mobile terminal 100 associated with the present disclosure, and FIG. 15 is a conceptual view of a cross-section taken along a line B-B′ of FIG. 14.

The light emitting diffuser 225 is formed by filling the antenna slit 223 of the support frame 220. The support frame 220 may be made of a metal, and the light emitting diffuser 225 may be made of a non-conductor. For example, the light emitting diffuser 225 may contain a resin composed of a light transmitting material.

The light emitting diffuser 225 may be double-injected with the support frame 220.

As described above, the light emitting diffuser 225 may be spaced apart from the light source 231 by a predetermined distance or greater to define a space. The light emitting diffuser 225 may define a hollow portion 2251 therein such that an inner surface of the light emitting diffuser 225 may maintain a predetermined distance from the light source 231. The hollow portion 2251 may have a recessed shape such that the inner surface of the light emitting diffuser 225 surrounds the light source 231. In this case, light emitted from the light source 231 may be uniformly spread to the light emitting diffuser 225 by minimizing a loss of the light.

The light source 231 may be mounted directly on the main printed circuit board 241 to transmit light to the light emitting diffuser 225. When the light source 231 is mounted directly on the main printed circuit board 241, a production cost may be minimized and volume increase of the mobile terminal 100 may be minimized since a separate member is not required.

However, in this case, since a position of the light source 231 may not be defined as desired with respect to a thickness direction of the mobile terminal 100, an amount of the light may be insufficient or the light may not be uniformly transmitted to the light emitting diffuser 225.

FIG. 16 is a partial front view of the mobile terminal 100 associated with the present disclosure.

In order to complement the problems of the above-mentioned embodiment, the slit light emitting unit 230c may be implemented in the indirect mounting scheme using the flexible printed circuit board (FPCB) 242. One side of the flexible printed circuit board 242 may be coupled to the main printed circuit board 241 and the other side thereof may mount the light source 231 thereon to emit light to the light emitting diffuser 225.

When the light source 231 is mounted on the flexible printed circuit board 242, a degree of freedom of disposition of the light source 231 is increased. That is, the light source 231 may be disposed at a position where a light emitting efficiency is the highest.

FIG. 17 is a cross-sectional view taken along a line C-C′ of FIG. 16.

In particular, a surface of the flexible printed circuit board 242 on which the light source 231 is mounted may be perpendicular to one surface of the main printed circuit board 241, so that a light emitting surface of the light source 231 may face a side of the mobile terminal 100. The light source 231 may be disposed near a center portion of the mobile terminal 100 with respect to a thickness direction of the mobile terminal 100. This is possible due to the provision of the flexible printed circuit board 242 irrespective of a position of the main printed circuit board 241.

In the structure of the slit light emitting unit 230c satisfying the above condition, light of the light source 231 may be uniformly transmitted to the light emitting diffuser 225 as compared with the embodiment of FIG. 15.

Features of the embodiment associated with the present drawing may be applied similarly to the embodiment of FIG. 15 within a range in which there is no contradiction.

FIG. 18 is an embodiment associated with the embodiments of FIGS. 14 and 16.

Unlike the shapes of FIGS. 15 and 17, the light emitting diffuser 225 may be connected to the light source 231 without having the hollow portion 2251 defined therein. One end 2253 of the light emitting diffuser 225 may be in contact with the light source 231, and the other end thereof may be exposed to the outside of the mobile terminal 100. A surface of one end of the light emitting diffuser 225 may be provided to correspond to an exposed surface of the light source 231.

The light emitting diffuser 225 may have a transmitting portion 2252 that has a cross-sectional area, which increases from one end of the transmitting portion 2252 to the other end thereof. The transmitting portion 2252 may allow the light source 231 to emit the light without the light loss, and may also serve to uniformly transmit the light.

A rate of increase of the cross-sectional area of the transmitting portion 2252 may be determined in consideration of the amount of the light of the light source 231, a width of the other side, and a distance from the other side to the light source 231.

FIG. 19 is an external perspective view of the mobile terminal 100, which is associated with an embodiment of the mobile terminal 100 associated with the present disclosure, and FIG. 20 shows a rear view of a corresponding region.

The light emitting diffuser 225 may be injected into the antenna slit 223 of the support frame 220 and then coupled with the antenna slit 223 through a curing process. However, due to a property of the material, the metal support frame 220 and the light transmitting resin may not be tightly coupled to each other. Therefore, a reinforcing resin portion 2241 may be disposed to ensure a coupling reliability.

The reinforcing resin portion 2241 may be thinly applied on the antenna slit 223 of the support, so that the light emitting diffuser 225 may be indirectly coupled to the support frame 220, thereby preventing problems such as peeling and the like.

After the reinforcing resin portion 2241 is applied on the support frame 220 and then cured, the light transmitting resin constituting the light emitting diffuser 225 may be injected and then cured.

The reinforcing resin portion 2241 may be made of the same material as the mold portion 224 that is injected and cured inside the support frame 220.

However, since the reinforcing resin portion 2241 is made of a material different from that of the light emitting diffuser 225 and the support frame 220, a sense of difference may occur.

FIG. 21 illustrates a rear view of an embodiment of a region of a support frame associated with the present disclosure.

As described above, in order to prevent the reinforcing resin portion 2241 from being seen to the outside of the mobile terminal 100, the reinforcing resin portion 2241 may be selectively applied for each region. As shown in FIG. 21, the reinforcing resin portion 2241 may not be disposed in a region near the outside of the antenna slit 223 of the support frame 220. As shown in FIG. 21, the reinforcing resin portion 2241 may not be disposed in a region near an outer side of the antenna slit 223 of the support frame 220. That is, the reinforcing resin portion 2241 is disposed only in one region of an inner side of the antenna slit 223, is not visible to the outside, and at the same time, maintains a bonding force with respect to said one region, so that a coupling force of the support frame 220 of the light emitting diffuser 225 may be maintained to be equal to or above a certain level.

FIG. 22 is a partial front view of the mobile terminal 100 associated with the present disclosure, and FIG. 23 is a cross-sectional view taken along a line D-D′ of FIG. 22.

Unlike the above-described embodiments, a light emitting structure may be positioned at a lower side of the display panel 151b based on the front surface of the mobile terminal 100.

In this connection, in order to minimize bezel increase, the flexible printed circuit board 242 mounting the light source 231 thereon may be positioned to be parallel to the thickness direction of the mobile terminal 100.

The light source 231 may emit the light. The emitted light may be reflected through a guide cap 261 and then emitted to the front surface of the mobile terminal 100 through a diffuser sheet.

It will be apparent to those skilled in the art that the present disclosure may be embodied in other specific forms without departing from the spirit and essential characteristics of the present disclosure.

The above detailed description should not be construed as limiting in all respects, but should be considered as illustrative. The scope of the present disclosure should be determined by reasonable interpretation of the appended claims. All changes within the equivalence range according to the present disclosure are included in a range under the present disclosure.

### INDUSTRIAL APPLICABILITY

All or some features of the present disclosure may be applied to the mobile terminal.

1. A mobile terminal comprising:
a display unit including a window and a display panel;
a support frame positioned at a rear of the display unit;
a wire receiving groove defined along an edge of the support frame;
a light emitting unit received in the wire receiving groove;
a decoration frame made of a light transmitting material, wherein the decoration frame covers an exposed region of the received light emitting unit; and
an opaque shielding frame disposed between the light emitting unit and the display panel.

2. The mobile terminal of claim 1, wherein the decoration frame and the shielding frame are formed integral with each other and made of a light transmitting material, and
wherein opaque paint is printed on the shielding frame.

3. The mobile terminal of claim 1, wherein the shielding frame forms a closed loop along a perimeter of the display panel, and
wherein the shielding frame further includes a reinforcing plate for blocking at least one region of an opening defined by the closed loop.

4. The mobile terminal of claim 1, wherein the reinforcing plate contains a metal material, and
wherein the shielding frame is double-injected with the reinforcing plate.

5. The mobile terminal of claim 1, further comprising:
a hook formed on the decoration frame, wherein the hook protrudes horizontally outward; and
a projection formed on the support frame, wherein the projection protrudes horizontally inward to be fastened with the hook.

6. The mobile terminal of claim 1, wherein the light emitting unit includes:
an optical fiber made of a non-conductive material; and
a light source disposed at one end of the optical fiber, wherein light emitted from the light source propagates into the optical fiber.

7. The mobile terminal of claim 6, wherein the light source is disposed at a position corresponding to a receiver or an input/output terminal in a main printed circuit board region.

8. The mobile terminal of claim 6, wherein the support frame contains a metal material,
wherein the support frame further includes:
an antenna slit defined in the support frame; and
a mold portion filling the antenna slit, and
wherein the optical fiber passes through a region corresponding to the antenna slit.

9. The mobile terminal of claim 1, wherein the light emitting unit includes an electroluminescent wire.

10. The mobile terminal of claim 9, wherein the support frame contains a metal material,
wherein the support frame further includes:
an antenna slit defined in the support frame; and
a mold portion filling the antenna slit, and
wherein the electroluminescent wire is spaced apart from a region corresponding to the antenna slit by a predetermined distance or greater.

11. A mobile terminal comprising:
a display unit;
a metal support frame positioned at a rear of the display unit, wherein the support frame forms a side outer shape of the mobile terminal;
at least one antenna slit defined in a side surface of the support frame;
a light transmissive light emitting diffuser;
a light transmissive diffuser disposed in the antenna slit; and
a light source disposed inside the light emitting diffuser.

12. The mobile terminal of claim 11, wherein the light emitting diffuser defines a hollow portion such that an inner surface of the light emitting diffuser is spaced apart from the light source.

13. The mobile terminal of claim 11, wherein the light emitting diffuser is disposed such that an inner surface of the light emitting diffuser is adjacent to the light source, and
wherein the light emitting diffuser further includes a transmitting portion having a cross-sectional area increasing outwardly.

14. The mobile terminal of claim 11, further comprising:
a main printed circuit board disposed on one surface of the support frame, and
wherein the light source is disposed on one surface of the main printed circuit board.

15. The mobile terminal of claim 11, further comprising:
a main printed circuit board disposed on one surface of the support frame; and
a flexible printed circuit board mounting the light source thereon, wherein the flexible printed circuit board is connected to the main printed circuit board, and
wherein a region of the flexible printed circuit board mounting the light source therein faces a side of the mobile terminal.

16. The mobile terminal of claim 11, further comprising:
a reinforcing resin portion disposed between the slit and the light emitting diffuser.
